(19) United States
(12) Patent Application Publication
(10) Pub. No.: US 2007/0002020 A1
(43) Pub. Date: Jan. 4, 2007

(54) Optical mouse

(75) Inventors: Craig S. Ranta, Redmond, WA (US); David D. Bohn, Fort Collins, CO (US); John M. Lutian, Bellevue, WA (US); Victor P. Drake, Clyde Hill, WA (US)

Correspondence Address: BANNER & WITCOFF LTD.,;ATTORNEYS FOR CLIENT NOS. 003797 & 013797, 1001 G STREET , N.W., SUITE 1100, WASHINGTON, DC, 20001-4597, US

(73) Assignee: Microsoft Corporation, Redmond, WA (US)

(21) Appl. No.: 11/168,486

(22) Filed: Jun. 29, 2005

(51) Int. Cl. G09G 5/08

(52) U.S. Cl. 345/166

(57) ABSTRACT

An optical mouse includes a housing, a remote sensing unit and an optical coupling. The remote sensing unit may include a sensor and the optical coupling may be a fiber optic cable and may connect the housing to the remote sensing unit. The fiber optic cable may also be transparent. Mechanical elements of the optical mouse, such as switches or scroll wheels may also be located within the housing of the device.

### BACKGROUND

An optical mouse is an input device for a computer that produces movement of a cursor on the display of the computer by sensing movement of the mouse over a flat surface via detection of changes in reflected light over the flat surface rather than by moving parts such as a roller ball.

A typical optical mouse has many components contained with its housing including, for example, a light-emitting diode (LED) for producing and directing light to an underlying flat surface, a lens for receiving reflected light, a complimentary metal-oxide semiconductor (CMOS) sensor for receiving the light from the lens, a camera for taking picture of the underlying flat surface, a digital signal processor (DSP) for analyzing images received from the camera and determining distance and velocity of movement of the optical mouse, and numerous electrical components. Any of the components, in particular, the sensor or camera may be relatively large and cumbersome and may add weight and size to the mouse. Thus, the overall design and ergonomics of the design of the mouse may be impacted by the necessity to include all of the components of the mouse that are required for proper functioning of the mouse. The resultant weight of the mouse may be detrimental for all computer users but is particularly detrimental for garners who may desire a lighter and more compact mouse for high speed movement.

FIGS. 1A, 1B, and 2 schematically illustrate a typical optical mouse and its internal circuit board and other components. As FIG. 1A illustrates, the typical optical mouse 100 is attached to a cable 101. The cable 101 provides operation of the optical mouse 100 by attaching a USB plug 102 of the optical mouse 100 to a mating port of a computer. Power is commonly provided from the computer to the mouse 100 via a cable 101 and USB plug 102. Suitable control signals are transmitted from the mouse 100 to computer to control the movement of the cursor.

The typical optical mouse has a housing 112 that contains the components of the optical mouse 100. Included in the housing 112 is a printed circuit board 111 onto which the components are connected. FIGS. 1B and 2 illustrate some of the components found in a typical optical mouse 100 including a light source or an LED 108 that produces and emits light via an illumination lens (not shown) located in the housing 112 and is reflected off a flat surface over which the optical mouse 100 is being moved. The reflected light from the flat surface is received at the optical mouse 100 and passes through an imaging lens 202 which focuses the reflected light onto a sensor 107 for receiving and sensing the pictures. These images are sent via numerous electrical components 103 to a Digital Signal Processor (DSP) 106 which analyzes the received images for changes in the images and generates signals based on the determined differences in the received images. These signals are converted to a format that the optical mouse may use by the Controller IC 105. The Controller IC 105 may further be regulated by the Clock 104 and are sent via an optical mouse cable to a computer.

The electrical cable 101 connecting the mouse 100 to the computer may act as an “antenna” which is subject to receiving noise. Ambient noise from the environment may be received through the electrical cable 101 to degrade performance of the mouse 100. Also, noise from the mouse 100 may be emitted via the electrical cable 101 to cause electromagnetic interference (EMI) and degrade performance of other devices. Copper or foil shielding is used along the entire length and at both ends of the electrical cable to prevent or minimize EMI. However, the addition of shielding is costly and severely restricts design options of the optical mouse (e.g., those designs in which the presence of shielding would be prohibitive).

Such an optical mouse requires manufacturing of all of the optical and electrical components within the housing. Because there are many components to consider in the design of an optical mouse, placement of the components may be a challenge in order to maximize the use of the limited amount of available space within the housing of the optical mouse. Certain features or electrical components often require placement at a certain location on the board within the housing of the mouse which may impede on and interfere with the optics. Also, ESD issues also apply to components within the housing of the mouse. Therefore, there are limitations on the placement of electrical components in the mouse. This may result in added costs or even suboptimal mouse designs.

The costs of manufacturing a typical optical mouse may be high because a manufacturer must consider not only functional capabilities with EMC/EMI issues that are required in the mouse but also ergonomic and aesthetic design considerations. Often functional and aesthetic needs conflict with design requirements or EMC/EMI issues and result in sacrificed ergonomic or aesthetic aspects.

### SUMMARY

The following presents a simplified summary. This summary is not an extensive overview of the invention. It is not intended to identify key or critical elements of the invention or to delineate the scope of the invention. The following summary merely presents selected aspects of the invention in a simplified form as a prelude to the more detailed description provided below.

In a first illustrative aspect, an optical mouse is provided with a housing, a remote sensing unit, and a flexible coupling. The remote sensing unit includes a center for detecting movement of a housing. The flexible housing optically couples the remote sensing unit and the housing. The remote sensing unit is located remotely from the housing and may include a connector for connecting to a computer.

In another aspect of an optical mouse, electronic components of the optical mouse are located in a remote sensing unit that connects to a computer while the housing of the optical mouse is located remotely from the remote sensing unit. The remote sensing unit and housing are connected via a flexible coupling, such as a fiber optic cable. Optical components of the device are contained in the remote sensing unit. Mechanical elements of the optical mouse, such as switches or scroll wheels may also be located on the housing of the device.

### BRIEF DESCRIPTION OF THE DRAWINGS

FIGS. 1A and 1B schematically illustrate a typical optical mouse attached to an optical cable.

FIG. 2 is a schematic block diagram illustrating a typical optical mouse.

FIGS. 3A-3D are schematic drawings illustrating examples of optical mice according to several aspects of the present invention.

FIG. 4 schematically illustrates an example of a flexible coupling according to one aspect of the present invention.

FIG. 5 schematically illustrates an example of an image pipe encoding method for tracking movement of an optical mouse according to one aspect of the present invention.

FIG. 6 schematically illustrates an example of a 4-bucket encoding method for tracking movement of an optical mouse according to one aspect of the present invention.

FIG. 7 schematically illustrates an example of a fiberoptic Doppler encoding method for tracking movement of an optical mouse according to one aspect of the present invention.

FIG. 8 schematically illustrates an example of a switch in an optical mouse according to one aspect of the present invention.

FIG. 9 schematically illustrates an example of a plurality of switches in an optical mouse according to one aspect of the present invention.

FIG. 10 schematically illustrates an example of an encoding method according to one aspect of the present invention in which a common light source drives a plurality of fibers for each of a plurality of switch elements.

FIG. 11 schematically illustrates an example of an encoding method in which switches are arranged in a matrix array.

FIG. 12 schematically illustrates an example of light detection using a scroll wheel.

FIG. 13 schematically illustrates an example of switch detection using modulation of the total optical path.

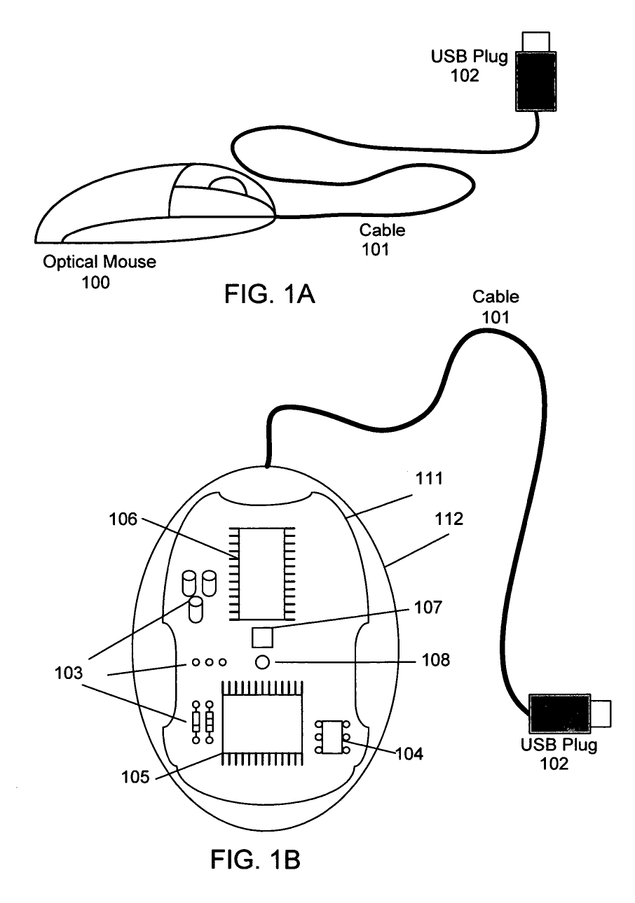

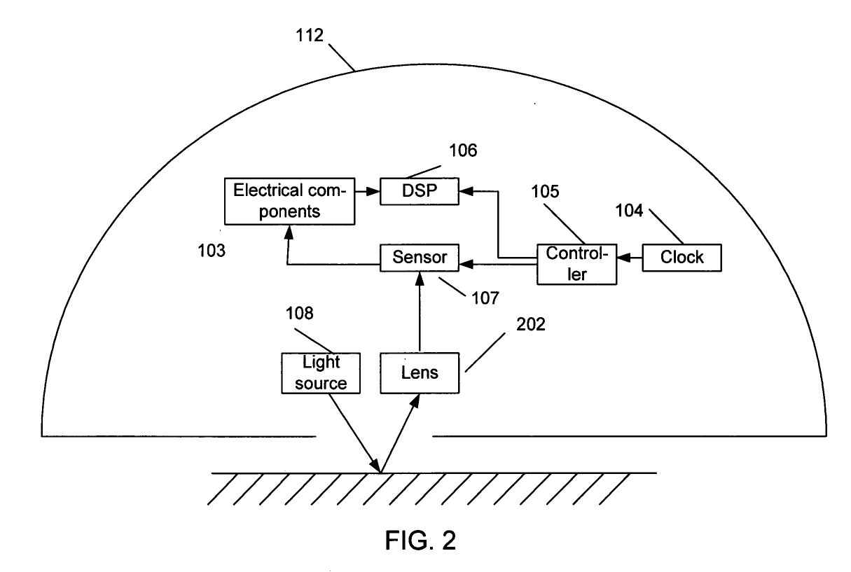

### DETAILED DESCRIPTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope of the present invention.

For purposes of simplification of the present description, the term “optical mouse” will be used to describe the device of the present invention but it will be clear from the present description that the optical mouse of the present invention differs from a typical optical mouse in content and function. The optical mouse of the present invention may be implemented in any suitable computing system.

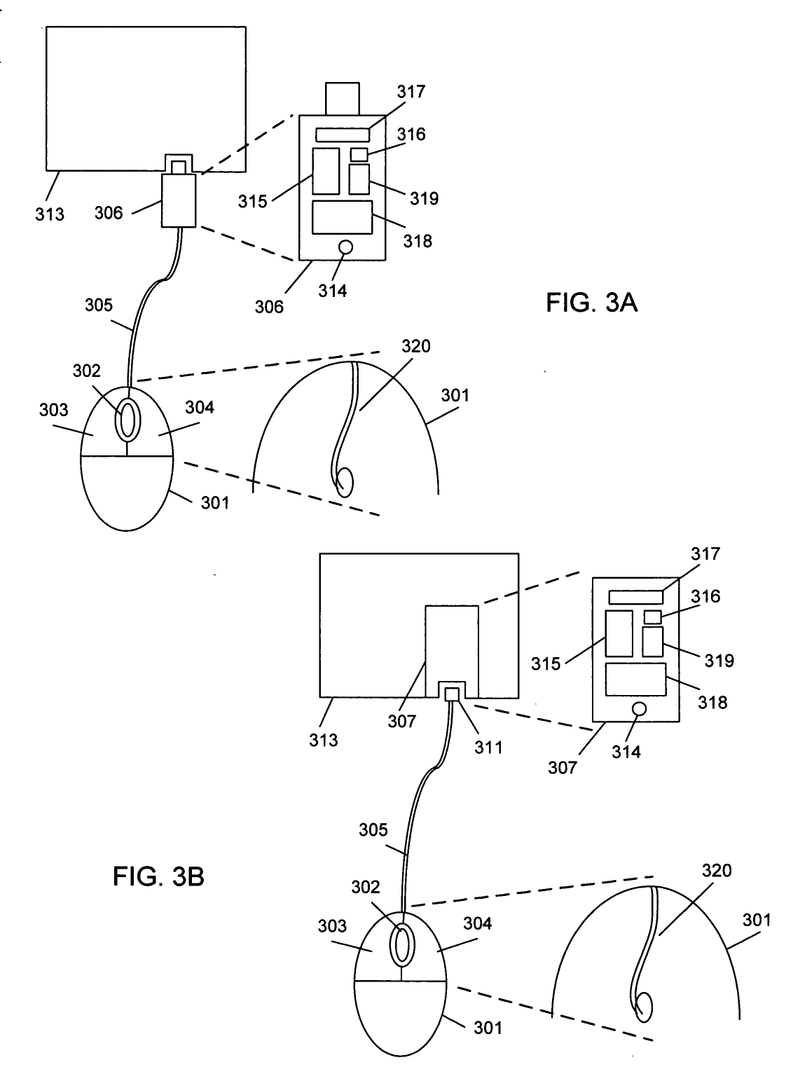

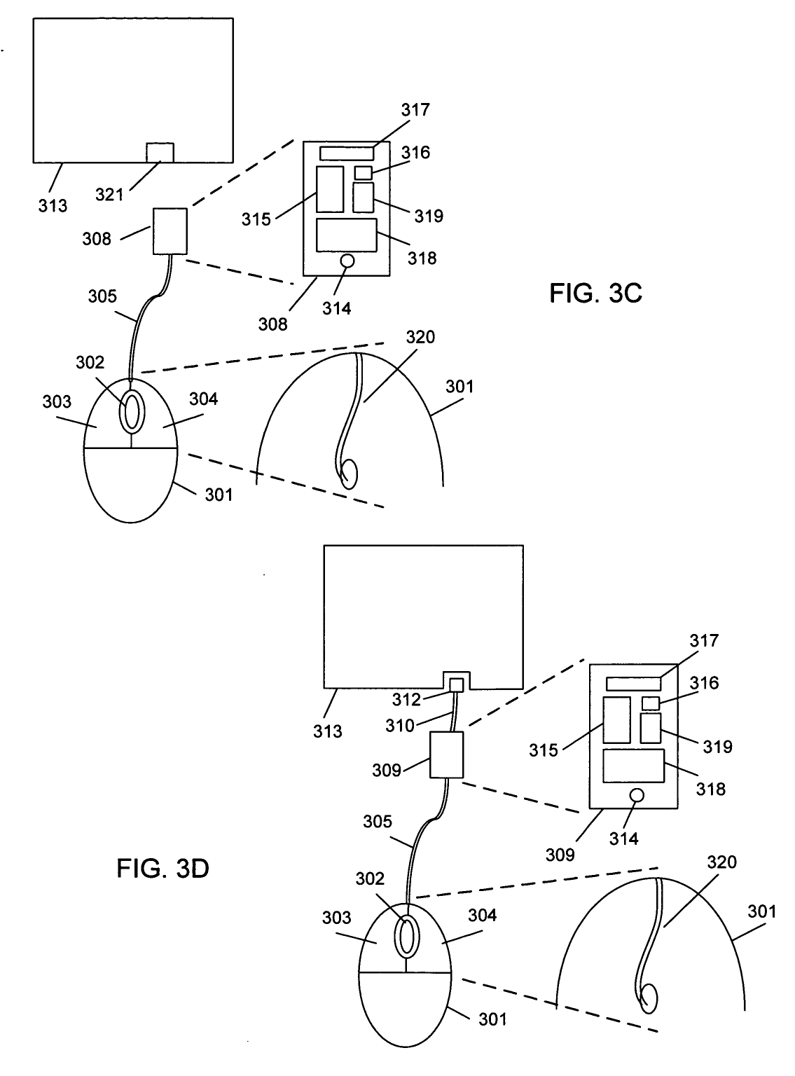

FIGS. 3A-3D illustrates examples of an optical mouse. In the example illustrated in FIG. 3A, the optical mouse has a housing 301 and a separate remote sensing unit 306 connected to the housing 301 through an elongated, flexible coupling such as a fiber optic cable 305. The remote sensing unit 306 connects to a computer 313 through a corresponding port in the computer 313. For example, the remote sensing unit 306 may connect to the computer 313 through a USB port. Movement of the housing 301 may be detected at the remote sensing unit 306 via the fiber optic cable 305. In this example, the remote sensing unit 306 contains components of the optical mouse for detecting or analyzing movement of the housing 301 such as a light source 314, a controller 315, a clock 316, electrical components 317, and a DSP 318 including a sensor 319 for detecting and analyzing images received from the housing 301 via the fiber optic cable 305.

The housing 301 of the optical mouse of FIG. 3A has a bottom surface that is substantially flat and that rides on a tracking surface. The housing also contains a fiber optic element 320 that directs light to an aperture in the bottom surface of the housing 301. Fiber optic element 320 can be, for example, a free end of the fiber optic cable 305 from the remote sensing unit 306. Alternatively, the fiber optic element 320 may be an optical fiber coupled to the housing which is separate from but optically coupled to the fiber optic cable 305. Also, the fiber optic element 320 may be an optical light pipe or other element that permits light transmission between the fiber optic cable 305 and the aperture in the bottom surface of the housing 301. For example, the light source 314 generates light in the remote sensing unit 316 which is transmitted via the fiber optic cable 305 to the housing 301. The light received at the housing 301 passes through a fiber optic element 320 within the housing 301 and through an aperture in the housing 301 to an underlying surface over which the housing 301 of the mouse is moved. The reflected light from the underlying surface returns to the housing 301 and is transmitted to the remote sensing unit 306 via the fiber optic cable 305. A variety of fiber optic cables may be used. For example, the fiber optic cable 305 may contain a bundle of fibers often termed “image guides”. In this example, each fiber may be associated with one pixel. The images of the surface underlying the housing 301 received at the remote sensing unit 306 are detected by the sensor 319 and analyzed, for example, by the DSP 318 within the remote sensing unit 306 and the distance, direction, and/or velocity of movement of the housing 301 is determined. The remote sensing unit 306 is connected to the computer 313 and signals corresponding to the movement of the housing 301 is sent from the remote sensing unit 306 to the computer 313 to correspondingly move a cursor on the display, and such cursor movement may be done according to rules set in a mouse driver program in the computer.

FIG. 3B illustrates another example of an optical mouse which is similar to the described and depicted arrangement and alternatives of the mouse of FIG. 3A, except it differs in that components within the remote sensing unit are instead contained in an interface coupled to the computer. Thus, the computer 313 contains an interface 307 that contains components to detect and analyze movement of the housing 301 and into which the fiber optic cable 305 connects. In this example, any type of remote sensing unit may be used to interface with the computer. For example, a USB port may be used to connect the fiber optic cable 305 to the computer interface 307.

Thus, in this example, reflected light from the housing 303 travels to the interface 307 in the computer 313. Changes in received images are detected changes at the sensor 319 within the interface 307 of the computer 313 and the velocity and direction of movement of the housing 301 is determined.

FIG. 3C illustrates another example of an optical mouse which is similar to the described and depicted arrangement and alternatives of the mouse of FIG. 3A, except the signals are transmitted via a wireless coupling. In this example, the remote sensing unit 308 contains components to detect and analyze movement of the housing 301 but the remote sensing unit 308 does not connect directly to the computer 313. Rather, in this example, the remote sensing unit 308 contains a wireless transmitter that can communicate signals corresponding to distance, direction and/or velocity of movement of the housing 301 wirelessly to the computer 313 (e.g., via an IR receiver/transmitter) which receives the signals wirelessly via an interface 321 configured to receive and process wireless signals. Based on the received signals, a pointer or image on the display moves in relation to the movement of the housing 301.

FIG. 3D illustrates another example of an optical mouse which is similar to the described and depicted arrangement and alternatives of the mouse of FIG. 3A, except an electrical cable 310 connects the remote sensing unit 309 to a computer 313 through, for example, a USB port or any similar connection.

In this example, light is reflected from the underlying surface to the housing 301 and is transmitted through the optic fiber cable 320 within the housing 301 to the optic fiber cable 305 connecting the housing 301 to the remote sensing unit 309. The reflected light then travels to the remote sensing unit 309 which receives, processes and analyzes the images to determine the distance, velocity and/or direction of movement of the housing 301. Signals corresponding to the movement of the housing 301 is then transmitted via an electrical cable 310 to a computer 313. The computer 313 receives the signals from the remote sensing unit 309 such that a pointer or image on a display is moved according to movement of the housing 301.

As FIGS. 3A-3D illustrate, the housing 301 may also contain mechanical parts of the optical mouse. For example, the optical mouse may contain one or more user control elements such as a primary or secondary button. The housing 301 may contain a scroll wheel 302 extending through an opening in the housing 301. The scroll wheel 302 may be user-engagable such that a user may manipulate the scroll wheel 302 (e.g., by endlessly rotating the scroll wheel 302 around a rotating axis within the housing 301 or by depressing the scroll wheel 302 to activate a Z-switch) to cause corresponding movement of a pointer or an image on a display or a corresponding function upon depression of the Z-switch. In addition, the housing 301 may contain button such as a primary key 303 or a secondary key 304 or any other suitable button in which depression of a button such as a primary key 303 or secondary key 304 may cause a corresponding action in a computer 313. In one arrangement, the housing contains a primary button, a secondary button, a scroll wheel, and a Z-switch.

The housing of the remote sensing unit 306 is shielded such that there is no interference in the device from electromagnetic interference (EMI) of the DSP 318 or other electrical components 317, for example. In this example, the remote sensing unit 306 is encapsulated with a copper shield to reduce or eliminate EMI, however, there is no need to encapsulate the fiber optic cable 305 or the housing 301 of the optical mouse when the electronic components 317, for example, of the optical mouse are located in the remote sensing unit 306 (or in an interface 307 of the computer 313). Thus, the optical mouse of FIG. 3 can be manufactured more inexpensively and efficiently.

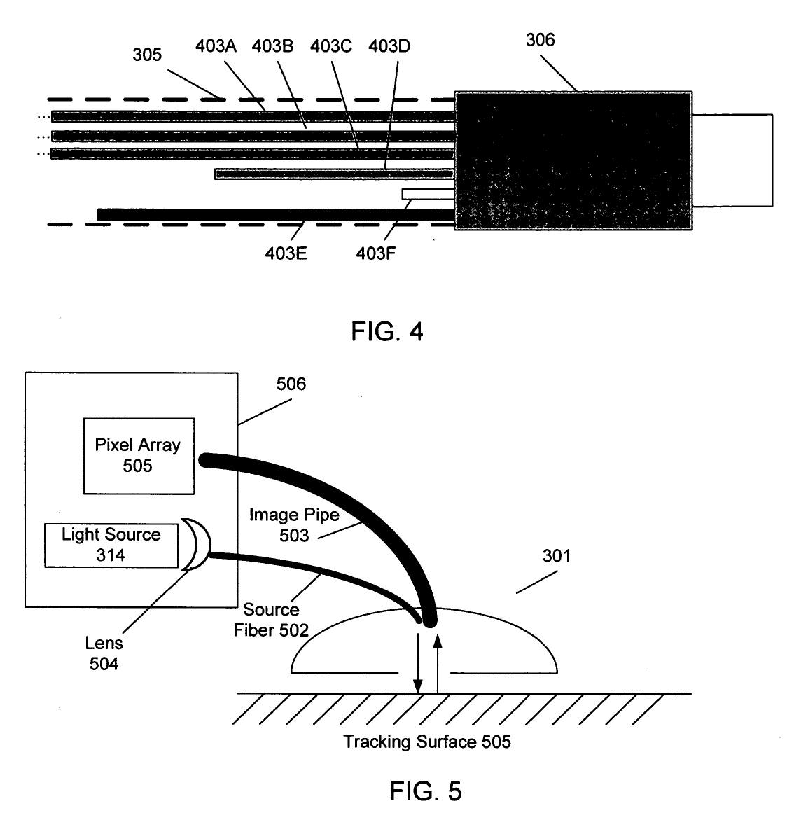

FIG. 4 schematically illustrates an illustrative arrangement of a fiber optic coupling. In this example, the fiber optic cable 305 is attached to a remote sensing unit 306, which in turn connects to a computer (not shown). The fiber optic cable 305 in this example contains waveguides (403A-F) for propagating light. Any number of waveguides may be used as desired. The remote sensing unit 306 contains all of the electronic components for the optical mouse (not shown). No shielding is needed in the fiber optic cable 305 because there is no electronic power or signals being transmitted by the fiber optic cable 305. As such, at least a portion of the fiber optic cable 305 along its length is transparent such that it is possible to see through the transparent portion(s) of the fiber optic cable 305. The transparency of the fiber optic cable 305 is illustrated in FIG. 4 as dotted lines.

Also shown in the example of FIG. 4, is the inclusion of waveguides 403A-403F within the fiber optic cable 305. Optical fibers carrying light to and from the housing may extend to or into the housing (403A-403C). In accordance with an embodiment, the fiber optic cable 305 may further include optical fibers that terminate short of the housing and or at different lengths along the fiber (403D-403F). Thus, at least some of the waveguides 403A-403F may be embedded within the transparent fiber optic cable 305 and may be of varying lengths. As illustrated in the example of FIG. 4, the waveguides 403D-403F are of varying lengths and may terminate at different locations throughout the length of the transparent fiber optic cable 305. Additionally, colors, lights, or other decorative features may be included with the waveguides 403 to create a unique appearance of the fiber optic cable 305. For example, the remote sensing unit 306 may contain components to power the waveguides 403A-403F to create illumination along different lengths of the fiber optic cable 305. The various illuminations in the fiber optic cable 305 may also be of varying colors or styles. In this example, the fiber optic cable 305 contains optical waveguides 403A-403F that communicate signals or navigation data through a transparent fiber optic cable 305. There are many ways in which different colors may be provided. For example, fluorescent material or dyes may be contained within the waveguides 403A-403F themselves as solids doped within the waveguides 403A-F.

FIG. 5 illustrates details of a first arrangement for tracking mouse movement along a tracking surface using an image pipe encoding method. As FIG. 5 illustrates, a light source 314, which may be located externally from the housing 301 as shown in conjunction with FIGS. 3A-3D. The remote sensing unit 506, for example, may be a remote sensing unit 306, 308, 309 (see FIGS. 3A-3D) that connects to a computer 313 or in a computer interface 307 within a computer 313 that interfaces with a fiber optic cable 305 that in turn connects with an optical mouse housing 301 or in a remote sensing unit 306 that transmits signals corresponding to movement of a housing 301 of an optical mouse. The light source 314 provides coherent light or non-coherent (e.g., white) light and may be any suitable light source. Non-limiting examples of suitable light sources include a Vertical Cavity Surface Emitting Laser (VCSEL) or a Light Emitting Diode (LED).

The light source 314 provides a light that may be further focused through a lens 504. The light is then transmitted from the remote sensing unit 506 to a housing 301 of an optical mouse via a flexible coupling, such as a fiber optic cable 305. The light is then provided to a tracking surface 505 through an aperture in the housing 301 of the optical mouse via a fiber optic cable 320 (see FIGS. 3A-3D) within the housing 301. The light is reflected off a tracking surface 505 underlying the housing 301 and upon which the housing 301 rests back to the housing 301 of the optical mouse where the reflected light is then transmitted to the remote sensing unit 506 which connects to a computer (e.g., via a USB plug, not shown). The light is transmitted to the remote sensing unit 506 via an image pipe 503.

The image pipe 503 contains fiber optic elements arranged in bundles. There may be a 1:1 equivalence between pixels and fiber optic elements. For example, light detection may be accomplished through a pixel array for which the image pipe 503 contains a fiber optic element for each of the pixels within the array. A pixel array 505 in this example senses and analyzes the received light reflected from the tracking surface 505 and transmitted from the housing 301 to the remote sensing unit 506. The pixel array 505 may be of any desired size. For example, the pixel array 505 may contain a 10×10 array of pixels, a 20×20 array of pixels, etc. Thus, if a 20×20 array of pixels is used and there is a 1:1 correspondence between the number of pixels and the number of fiber optic elements (i.e., fibers), there would be 400 fibers forming the image pipe 503. Likewise the optical mouse may also contain other switches, for example, for a scroll wheel 302, primary key 303, secondary key 304, etc. Switches may also have corresponding fibers that may send signals from the housing 301 to a remote sensing unit 306 (which connects to a computer 313) where electrical components of the optical mouse is located.

In this example, the pixel array sensor 505 is located within the remote sensing unit 506 rather than the housing 301 itself. The free ends for each of the fibers are exposed to the sensor (i.e., the pixel array 505 in this example). In this example, images are transferred from the tracking surface 505 via reflected light received in the housing 301, then transmitted through the image pipe 503 which are part of a flexible coupling (i.e., fiber optic cable 305, see FIGS. 3A-3D) to a remote sensing unit 506. Thus, electrical components of the optical mouse may be located in a remote sensing unit 506 which is remote from a movable housing 301. Communication between the housing 301 and the remote sensing unit 506, such as transmission of light or images for detection and characterization of mouse movement, may be accomplished via a fiber optic cable 305 (see FIGS. 3A-3D, for example).

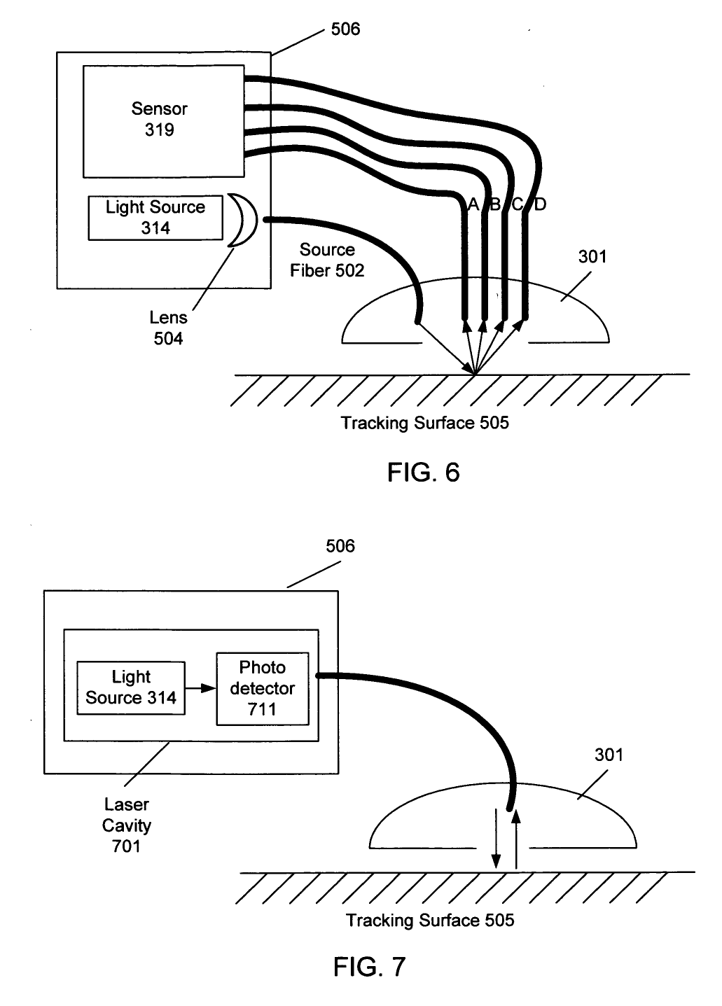

FIG. 6 illustrates an arrangement for tracking mouse movement using a Four Bucket encoding method. In this example, a light source 314, such as a laser, in a remote sensing unit 506 provides coherent light through a lens 504 to a fiber optic cable 305 (see FIGS. 3A-3D, for example). The remote sensing unit 506, for example, may be a remote sensing unit 306, 308, 309 (see FIGS. 3A-3D) that connects to a computer 313 or in a computer interface 307 within a computer 313 that interfaces with a fiber optic cable 305 that in turn connects with an optical mouse housing 301 or in a remote sensing unit 306 that transmits signals corresponding to movement of a housing 301 of an optical mouse. The light is transmitted through waveguides in the fiber optic cable 305 (see FIGS. 3A-3D, for example) to a housing 301 of an optical mouse. The light is then transmitted through the housing 301 of the optical mouse via a fiber optic cable 320 (see FIGS. 3A-3D) within the housing 301 and is transmitted through an aperture of the housing onto an underlying tracking surface 505. As the housing 301 is moved over the tracking surface 505, light strikes the tracking surface 505 and reflects back creating a speckle pattern (i.e., an interference pattern created when a laser bounces off the tracking surface 505 that returns to the remote sensing unit 506 via the fiber optic cable 305, and cancels out outgoing lasers to cause light and dark spots) which are detected and analyzed by a sensor 319.

In this example, motion of the housing 301 is detected according to an axis of movement. For example, movement of the housing 301 in the X axis is detected by a set of light sensing elements within the remote sensing unit 506 arranged in a linear array in which the light sensing elements are aligned parallel to the axis of the detected motion. A second set of light sensing elements may be aligned perpendicular to the first set of light sensing elements such that movement may be detected in the X and Y axes. Typically, four light sensing elements are used for each axes of movement detection. Hence, in this example, a first group of four light sensing elements are aligned linearly with each other along a first axis and a second group of four light sensing elements are aligned linearly with each other along a second axis, the first axis being approximately perpendicular to the second axis.

As the housing 301 is moved, the tracking surface 505 underlying the housing 301 moves relative to the housing 301. The light or laser scatters off the tracking surface 505 and received at the housing 301 and transmitted to the remote sensing unit 506 via the flexible coupling (e.g., fiber optic cable 305—see FIGS. 3A-3D) produces the laser speckle in the form of light and dark spots. As the spots move by the light sensing elements in the remote sensing unit 506, the position of the housing 301 and the velocity of movement is detected. The movement of the housing 301 is detected in the remote sensing unit 506 by a first group of linearly arranged light sensing elements in a direction parallel to the alignment of the light sensing elements. There may be additional groups of linearly arranged light sensing elements such that the movement in the direction of the alignment of each of the additional groups of linearly arranged light sensing elements is detected. For example, two groups of linearly arranged light sensing elements arranged perpendicular to each other may be provided such that movement and velocity of the optical mouse in the X and Y directions may be detected.

As FIG. 6 illustrates, the reflected light is transmitted via light sensing elements A, B, C, and D that are detected by linearly arranged light sensing elements in a sensor 319 in the remote sensing unit 506. Detection of movement parallel to the alignment of the four light sensing elements (A, B, C, and D) is performed by analysis of the laser speckle pattern from the received images in the remote sensing unit 506. The remote sensing unit 506 connects with a computer. The transmission of light from the housing 301 to the remote sensing unit 506 may be via a flexible coupling (e.g., a fiber optic cable 305, see FIGS. 3A-3D) connecting the housing 301 with the remote sensing unit 506. In addition to the sensor 319 (e.g., pixel array or photo-diode array), other electronic components may be located in the remote sensing unit 506 such that encoding may be accomplished within the remote sensing unit 506. In one method of encoding, the phase of the speckle position within the array may be determined from a tangent calculation based on the intensity of the reflected laser as follows:
Phase, θ=arctan [(D−B)/A−C)]

This phase equation calculates the absolute phase of a speckle image within the pixel array. Changes in phase in subsequent images are likewise calculated with physical movement being shown by changes of pi radians in phase that is equal to the length of the linear array of light sensing elements. In this example, four fibers are used for each direction of movement to be detected.

FIG. 7 illustrates a movement tracking system using a Fiberoptic Doppler encoding method. In this example, a suitable light, such as a laser, is produced by a light source 314 within a laser cavity 701. The light source 314 and laser cavity 701 may be located, for example, in a remote sensing unit 506 and may provide light to a housing 301 of an optical mouse via a flexible coupling (e.g., a fiber optic cable 305—see FIGS. 3A-3D, for example). The light is transmitted within the housing 301 via a fiber optic cable 320 (see FIGS. 3A-3D, for example) and is transmitted through an aperture of the housing 301 to an underlying tracking surface 505. A sensor may be located in the remote sensing unit 506 coupled to laser diodes which may be part of the laser cavity. Such a sensor may be used to determine X-Y displacement of the mouse.

As one non-limiting example, a single mode Vertical Cavity Surface Emitting Laser (VCSEL) may be used as a light source 314, which may include laser diodes, the brightness of which may be controlled by photodetector 711. The photodetector 711 may be contained in the same package as the laser, for example, or may be separate. The light is transmitted via a flexible coupling (e.g., fiber optic cable 305—see FIGS. 3A-3D, for example) from the laser cavity 701 in the remote sensing unit to a housing 301. Within the housing 301, the light may travel via a fiber optic cable 320 (see FIGS. 3A-3D, for example) within the housing 301 and may be transmitted through an aperture in the housing 301 to a tracking surface 505 underlying the housing 301. The light may then be reflected from the tracking surface 505 back to the housing 301 and then transmitted via the fiber optic cable 320 (see FIGS. 3A-3D, for example) within the housing 301 to the flexible coupling (e.g., a fiber optic cable 305 which may be continuous with the fiber optic cable 320 within the housing 301). The flexible coupling (e.g., the fiber optic cable 305, FIGS. 3A-3D) in this example is connected at one end to the housing 301 (or the fiber optic cable 320 (FIGS. 3A-3D) within the housing 301) and connected at the other end to the remote sensing unit 506 which connects with a computer. Alternatively, the flexible coupling (e.g., the fiber optic cable 305) may connect the housing 301 directly to the computer at an interface 307, the interface 307 of the computer containing the laser cavity 701 and light source 314.

For example, the light source 314 within the remote sensing unit 506 produces light that is transmitted from the laser cavity 701 from within the remote sensing unit 506 to the housing 301 via a flexible coupling (e.g., a fiber optic cable 305) (see FIGS. 3A-3D, for example). The light is directed to the tracking surface 505 underlying the housing 301 and is reflected back to the housing 301. The reflected light is transmitted from the housing 301 to the remote sensing unit 506 via the flexible coupling (e.g., fiber optic cable 305, FIGS. 3A-3D). In the remote sensing unit 506, the reflected light returns to the laser cavity 701 and mixes with the original light. This mixing of the original light with the reflected light distorts the original light. The distortion of the original laser light includes modulation of the amplitude of the light that may be proportional to the velocity of the relative movement of the device over the tracking surface 505. Hence, in this example, the laser cavity 701 is also the mixing cavity in which the reflected laser is mixed with the original light to cause the modulation of amplitude. Alternatively, the mixing cavity may be separate from the laser cavity 701, if desired.

The light source 314 and laser diodes may also include an integral photodetector or detector. The detector may detect the beat frequency that forms upon the distortion of the original light with mixing with the reflected light. Based on the distortion or beat frequency detected in the remote sensing unit 506, movement of the housing 301 over the tracking surface 505 may be detected. Moreover, the movement of the housing 301 may be detected in more than one direction. For example, an X and Y direction of movement may be detected from the distortion of light via a fiber for the X direction and another fiber for the Y direction. Additional fibers may be used as needed, such as but not limited to fibers corresponding to switches. However, for detection and characterization of the direction of movement and speed of the device, only two fibers are needed with each fiber corresponding to a dimension of movement being measured.

Different fibers may be used in combination with certain detectors. Examples of fibers that may be used include fluorinated polymers or regular polymer fibers. Examples of lasers that may be used include infrared lasers or LEDs. The light transmitted may be at any number of wavelengths, for example at 640 nm (red wavelengths) or 850 nm (infrared). There examples are not intended to limit the present invention as any fiber or laser may be used over different wavelengths.

In addition to tracking displacement of a housing 301 relative to a tracking surface 505, the optical mouse may also include switches for additional input. For example, the optical mouse of the present invention may contain a primary key 303 and a secondary key 304 or any additional keys for performing desired functions, such as but not limited to a scroll wheel 302, Z-switch, or any other suitable buttons or operators (see, e.g., FIGS. 3A-3D). Any of the switches, buttons or scroll wheels of the optical mouse may be associated with optic fibers that may extend from the housing to a remote sensing unit through a flexible coupling (e.g., flexible coupling 305 of FIGS. 3A-3D). For example an optic fiber may be associated with a switch in the housing of the optical mouse such that activation of the switch may alter the transmission of light over the associated optic fiber.

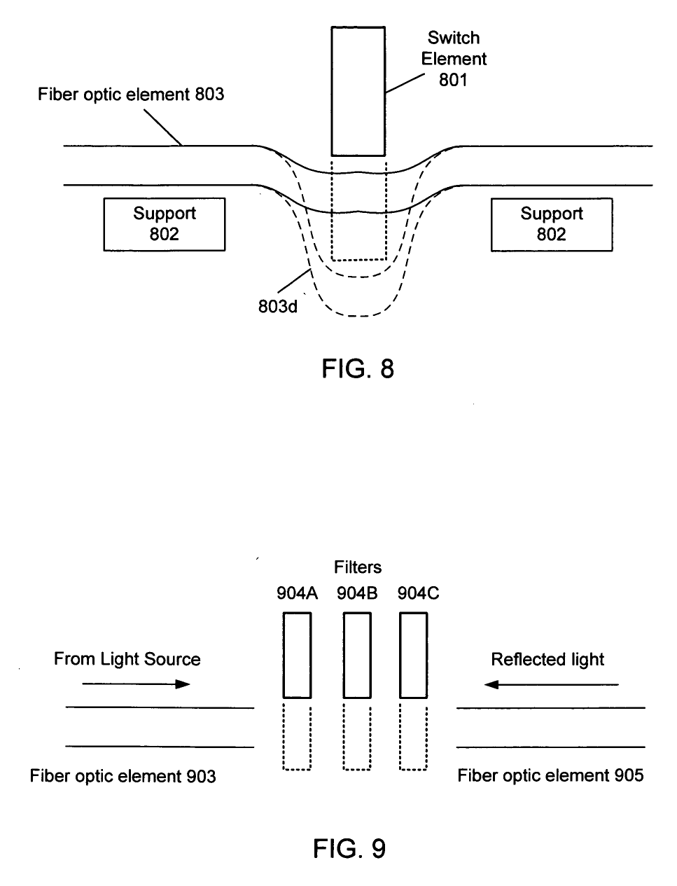

FIG. 8 illustrates an example of switch operation in an optical mouse of the present invention. In this example, the position of a switch modulates optical impedance of a fiber optic element. The modulation of optical impedance of the fiber optic element causes changes in the Total Internal Reflection (TIR) of the optic fiber. For example, TIR of the optic fiber may be at least partially lost upon bending of the optic fiber beyond a critical angle and a resultant change in optical impedance. This change in optical impedance may be detected by electronic circuitry located remotely from the housing of the optical mouse. For example, the electronic circuitry of the mouse may be contained in the remote sensing unit which connects to a computer.

In the example illustrated in FIG. 8, a fiber optic element 803 passes over supports 802. A switch element 801 may be coupled to buttons (not shown) on a housing such that depression of a button can result in a corresponding displacement of the switch element 801. Thus, the switch element 801 positioned over the fiber optic element 803 may be displaced with the depression of a corresponding button such that the switch element 801 impinges on the fiber optic element 803. In this example an optic fiber contains a core (or light carrying portion of the fiber) surrounded by cladding (not shown). The core has an index of refraction that is higher than that of the cladding such that light traveling in the optic fiber is trapped by waveguides within a guiding region of the optic fiber (Total Internal Reflection, TIR). There is a minimum critical angle at which the light strikes the core/cladding interface so that the light continues to be contained within the core of the fiber. As the light strikes the core/cladding interface and is reflected from the interface, the angle of incidence and the angle of reflection are equal and are greater than the minimum critical angle. This causes the light to propagate down the length of the fiber (TIR). However, if the angle at which the light strikes the core/cladding interface is less than the minimum critical angle, the light is not reflected back into the fiber. Rather, the light passes into the cladding and is lost.

In this example, depression of the switch element 801 causes deformation or bending of the fiber optic element 803 (803d—dotted lines). When the switch element 801 is not depressed, light may be transmitted over the fiber optic element 803 as described above. However, when the switch element 801 is depressed onto the fiber optic element 803, the fiber optic element 803 becomes deformed. When the fiber optic element 803 is deformed beyond a critical radius, the incident angle that the light forms upon striking the core/cladding interface falls below the minimum critical angle and light from the fiber optic element 803 escapes into the cladding. Thus, in this example, bending of the fiber optic element 803 beyond a critical threshold interferes with the TIR to create two different states of optical impedance of the fiber optic element 803. The different optical impedance states are detected.

The example illustrated in FIG. 8 shows a fiber optic element 803 over which light is transmitted from a source to a destination and is reflected from the destination back to the source over the fiber optic element 803. However, light may also be reflected back to the source from the destination over a separate fiber optic element (not shown). For example, a first fiber optic element may transmit light from a source (e.g., light source in a remote sensing unit) to a destination (e.g., a tracking surface underlying a housing of an optical mouse). The light may be reflected from a tracking surface and may return to the source (e.g., a remote sensing unit) via a second fiber optic element that is separate from the first fiber optic element. Thus depression of a switch element may impinge on the first fiber optic element but may not affect the second fiber optic element. Alternatively, depression of the switch element may impinge on the second fiber optic element but may not affect the first fiber optic element. Any number of fiber optic elements may be used in this example. Also a single fiber optic element may be used that loops back upon itself such that a first portion of the fiber optic element transmits light in one direction while a second portion of the fiber optic element transmits light in the reverse direction. Depression of a switch element may impinge on either portion of the fiber optic element or both portions, as desired.

Alternatively, optic fibers may be subject to Frustrated Total Internal Reflection (FTIR) in which optic fibers may be used such that the switching element need not bend the fiber to a critical radius to couple out light. In this example, the fiber optic element does not contain a cladding layer. Rather, the surrounding air functions as a cladding layer. Thus, when a switch comes into contact with the fiber, even if there is no deformation of the optic fiber itself, the contact causes light to escape from the fiber.

In addition, multiple switches may be used on a single fiber optic element (or multiple fiber optic elements). In one example, different switches may create a different bend radius in the optic fiber. Thus, the amount of attenuation may be controlled based on the number or relative position of the switches that are depressed. In another example, each switch causes a different number of bends in the optic fiber. For example, a first switch may cause a single bend in the optic fiber whereas a second switch may cause more than one bend in the optic fiber. As the number of bends increases based on which switch is depressed, the optic fiber may surpass a critical number of bends and light may then escape. As described above, the multiple switches may be applied to any number of fiber optic elements transmitting light in either direction.

FIG. 9 illustrates an example of optical attenuation of an optical path through the use of filters. In this example, a set of filters (904A-904C) are placed between an optic fiber from an optical light source and an optic fiber returning reflected light to the source. As FIG. 9 illustrates, the optic fibers in a fiber optic element 903 from the optical light source and the optic fibers in a fiber optic element 905 returning reflected light may be aligned in a linear fashion with any number of filters (904A-904C) in between. The filters (904A-904C) are associated with corresponding buttons (not shown) such that when a button is depressed, there is a corresponding displacement of a corresponding filter (904A-904C). The buttons may be associated with corresponding filters (904A-904C) of varying densities to control the passage of light. For example, if each of the filters differed in density by a factor of 2, then depressing one filter (e.g., 904A) may result in attenuation of the light by a factor of two. Similarly, depressing two filters (e.g., 904A and 904B) would increase the attenuation of light by a corresponding factor. Also, if a ratio of 2:1 is maintained between successive filters, the device may sense the presence of multiple filters. This information may be deduced from the total amount of light that is sensed.

As an alternative, light being transmitted from a source to a destination may be transmitted over a first fiber optic element while reflected light returning to the source may be transmitted over a second fiber optic element. In this example, any combination of filters 904A-C may be depressed to control the passage of light from the light source to the destination over the first fiber optic element. However, reflected light may be returned to a sensor over a separate fiber optic element that is not affected by depression of the filters (904A-904C). Thus, reflected light is not altered by depression of the filters (904A-904C). Alternatively, a subset of filters (904A-904C) may be used to control the transmission of light over the first fiber optic element while a second subset of filters (904A-904C) may be used to control transmission of reflected light over the second fiber optic element.

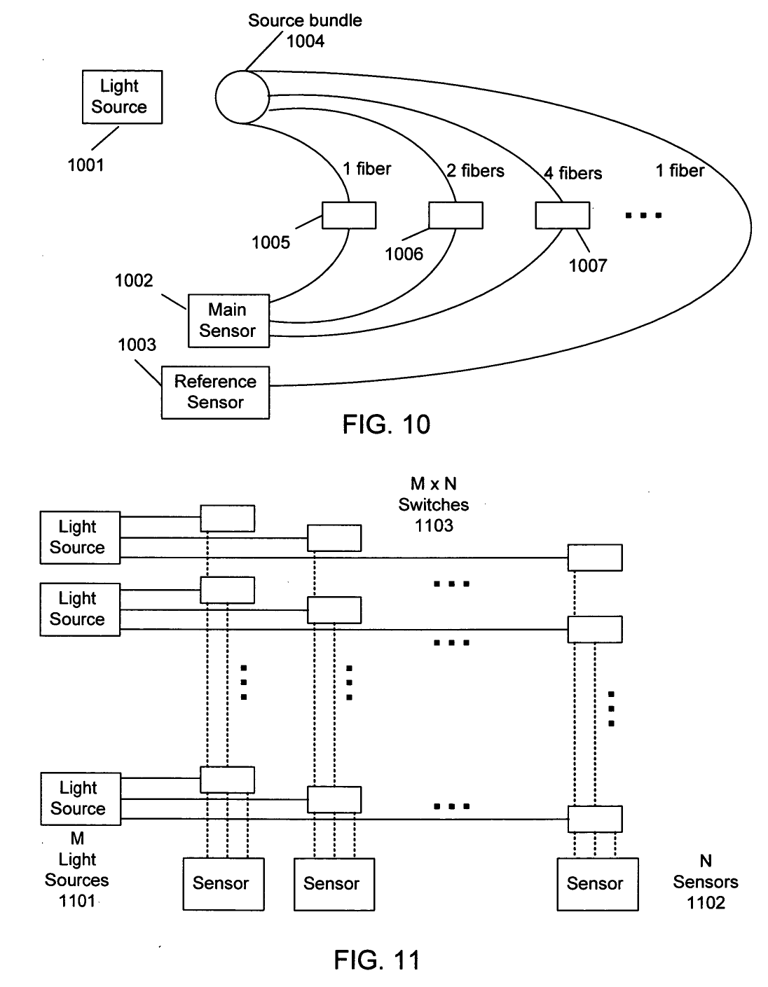

FIG. 10 illustrates an alternative example of optical encoding with a common light source 1001 that supplies light to a different number of fibers for each of multiple switch elements (1005, 1006, 1007). In this example, a light source 1001 provides light to a source bundle 1004 of optic fibers which provides light to each of the switch elements (1005, 1006, 1007). There are 3 switch elements (first switch element 1005, second switch element 1006 and third switch element 1007) in this example although any number of switch elements may be used. In this example, the first switch element 1005 receives one optic fiber, the second switch element 1006 receives two fibers, and the third switch element 1007 receives four fibers. It is noted that this configuration is merely an example and is not meant to limit the present invention. Any number of switches may be used and any number of fibers may be associated with any of the switches. The switches may be of any suitable type. For example, the switches may be a primary or secondary key that may be depressed by a user to perform a desired function. The switch may also be a scroll wheel or Z-switch. The present invention is not so limited, however, as any switch may be used in the present invention.

The amount of light that is transmitted in this example and is received at the main sensor 1002 may vary based on the amount of light that is blocked when a switch element (e.g., primary key, secondary key, Z-switch, scroll wheel, etc.) is depressed. Although in this example a single main sensor 1002 is used, multiple sensors may also be used, if desired. For example, a separate sensor may be used, each separate sensor corresponding to a particular switch element or a subset of certain switch elements.

In the present example, the amount of light that is blocked by the switch elements is varied by the number of corresponding fibers associated with each of the switch elements. In this example, the switch elements differ in the number of fibers from the source bundle 1004 in a ratio of 2:1. For example, if switch element 1005 is depressed, light from one fiber is blocked. However, if switch element 1006 is depressed, light from two fibers is blocked.

Also, a reference sensor 1003 may be provided. In this example, the reference sensor 1003 receives one fiber from the source bundle 1004. Thus, the reference sensor 1003 determines the amount of light intensity associated with a single fiber which may be used to determine the total number of fibers that are illuminating the main sensor. After the total number of fibers illuminating the main sensor is determined, the state of each switch may be determined. In this example, if the total number of fibers illuminating the main sensor 1002 is 6, then the first switch element is depressed and the second and third switch elements are not depressed. If the total number of fibers illuminating the main sensor 1002 is 5, then the second switch element is depressed and the first and third switch elements are not depressed. Similarly, if the total number of fibers illuminating the main sensor 1002 is 3, then the third switch element is depressed and the first and second switch elements are not depressed.

Also, a change in the structure of the cable itself that changes the total transmission of the light may be detected via the reference sensor 1003. If changes in light are detected at the main sensor 1002 but a corresponding change is also detected at the reference sensor 1003, then the changes in light may be attributed to collateral effects that are not related to the activation of switches. Thus, such collateral effects may be detected and adjustments may be made accordingly.

FIG. 11 illustrates another example of an encoding method using switches 1103 arranged in an array. In this example, each of the switches 1103 block all of the light received at the respective switches when the switch 1103 is activated. As FIG. 11 illustrates, there are M light sources 1101, N sensors 1102 in the system, and M×N switches 1103. The switches 1103 are further arranged in an M×N array as illustrated in FIG. 11. As known light sources 1101 are illuminated, each sensor 1102 determines the amount of light received. Based on the amount of light received at each sensor 1102 with the light sources 1101 that are illuminated, the system can decode the matrix of switches 1103 to detect which switches 1103 are depressed. Also, a reference fiber may also be used in this example (not shown) as described above.

A scroll wheel may also be implemented as a pair of switch elements arrayed in quadrature. As the scroll wheel is turned, the light is blocked or passed through based on the position of the scroll wheel. In one example, a 90° quadrature angle between the states of the two switch elements would be implemented. Thus, the scroll wheel provides mechanical blocking of light similar to a mechanical encoder.

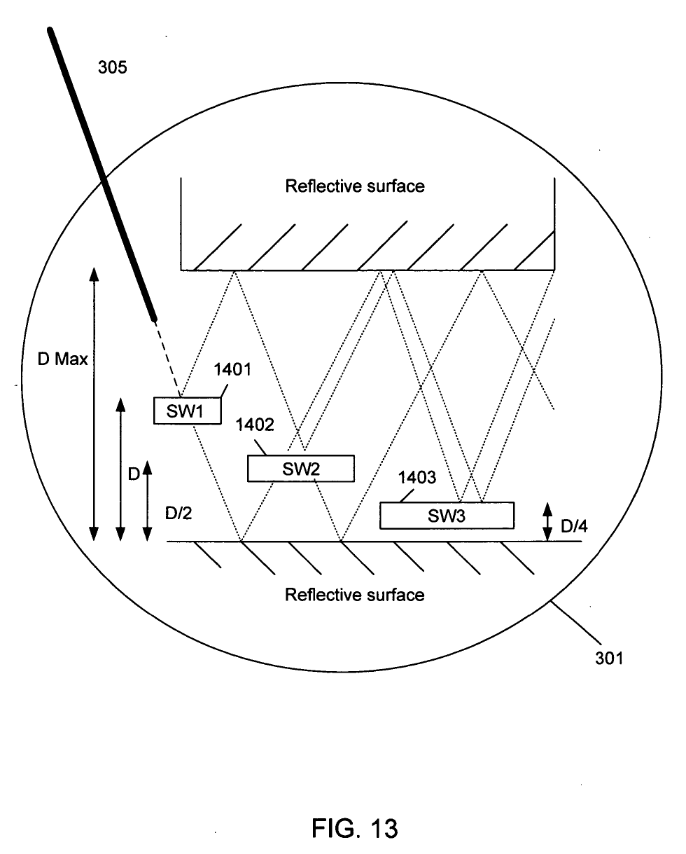

FIG. 13 illustrates an example of an encoding method using switches and multiple reflective surfaces. In this example, the total optical path of light is altered by the user of switches with reflective surfaces arranged in relation to each other by a factor of two. Light is received via a fiber optic cable 305. As previously described, light may be transmitted to the housing 301 from a remote sensing unit that communicates with a computer or is connected with the computer or is integrated with the computer. The light is transmitted from the remote sensing unit to the housing 301 and reflected off a first switch 1401 within the housing 301. The switches (1401, 1402, 1403) in this example are arranged between two reflective surfaces within the housing 301 that define the maximum space for placing the switches (D Max). Each of the switches (1401, 1402, 1403) are separated by a neighboring switch by a factor of 2. For example, the second switch 1402 is placed one half the distance to a reflective surface as the first switch 1401 and twice the distance to the reflective surface as a third switch 1403. When a switch is depressed, a corresponding reflective surface associated with the depressed switch is introduced. This causes incident light to reflect off the reflective surface and changes the total optical path. Based on the change in the total optical path and the spacing relationships of the switches, movement of the housing 301 is detected in the remote sensing unit.

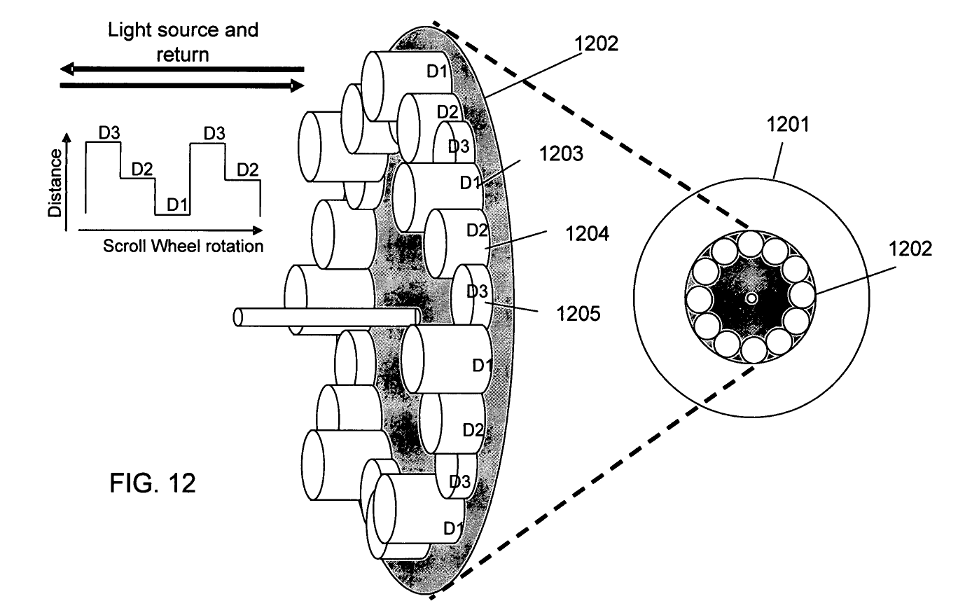

FIG. 12 illustrates an example of light detection using a scroll wheel in which the distance that light travels is controlled by rotation of a scroll wheel. In this example, a rotatable scroll wheel has a plurality of light reflective elements positioned at different heights with respect to a light source. Rotation of the rotatable scroll wheel produces discrete steps of varying distances over which light travels based on the relative heights of the light reflective surfaces of the light reflective elements. As the scroll wheel is rotated, the distance the light travels changes based on the angular orientation of the scroll wheel. Thus, the motion of the scroll wheel can be determined. In FIG. 12, a scroll wheel 1201 is illustrated containing a circumferentially arranged plurality of projections on a side 1202. An enlarged side-view illustration of the plurality of projections is indicated by the dotted lines in FIG. 12. As the side-view illustration of FIG. 12 illustrates in this example, a plurality of projections of varying heights (1203, 1204, and 1205) are provided. In this example, 3 different heights are provided: D1, D2 and D3 (corresponding to projections 1203, 1204, and 1205, respectively). Because there are more than two different heights of the light reflective elements arranged on the rotatable scroll wheel, the direction of the rotation may also be determined.

In an alternate example, each of the elements on the rotatable scroll wheel is a filtering element through which light may pass. In this example, the incoming light passes through a filtering element on the rotatable scroll wheel. As the scroll wheel is rotated, the angular orientation of the scroll wheel determines through which filtering element light passes. Based on the light the light that passes through a corresponding filter, rotation of the scroll wheel may be detected.

Incoming light is illustrated in FIG. 12 as approaching the plurality of projections. As the scroll wheel is rotated, the distance that the incident light will travel will change based on the height of the projection from the scroll wheel that is coincident with the incident light. If the incident light strikes a D1 projection 1203, the distance traveled is shorter than if the incident light strikes a D2 projection 1204, which in turn is shorter than if the incident light strikes a D3 projection 1205. Thus, the reflected light is from the scroll wheel is altered based on the position and movement of the scroll wheel and is detected and analyzed when received at a sensor. In this example, three steps are used in determining the movement and position of the scroll wheel so that the direction of movement of the wheel may also be detected. However, any number of steps greater than two may be used.

Thus, the optical mouse may be manufactured and produced in a low-cost, efficient manner and permits design characteristics that have heretofore been impossible to achieve because of conflicts with the functional or practical needs of the mouse. The optical mouse is also lighter and easier to maneuver while resolving EMC and EMI problems in a cost-effective manner. The optical mouse of the present invention may be implemented in any suitable computing system.

Thus it is clear that the figures present an optical mouse that is manufactured and produced in a low-cost, efficient manner while also minimizing EMC and EMI issues. The device of the present invention resembles a typical optical mouse to the extent that the device controls movement of a pointer on a display screen. However, the device of the present invention is easy to maneuver for the user and may possess design characteristics that have heretofore been impossible to achieve in a typical optical mouse because of conflicts with the functional or practical needs.

The present invention provides an optical mouse with a housing in which the components for detecting and analyzing movement of the optical mouse are situated remote from the housing. In one example, the optical mouse of the present invention contains a portion of an optical fiber for transmitting light through an aperture in the housing to an underlying surface over which the housing of the optical mouse may be moved. The components for detecting and analyzing movement of the housing may be located in a remote sensing unit which is separate from the housing but attached to the housing via a flexible coupling, for example, an optic fiber cable. The optic fiber cable that connects the housing with the remote sensing unit need not contain shielding for prevention of electromagnetic interference, thus lowering manufacturing costs. Without the need for shielding of the cable, the optic fiber cable may be entirely transparent through a cross section of the optic fiber cable in at least one longitudinal portion of the cable.

Manufacturing costs may also be reduced as the housing may be manufactured separately from the components for detecting and analyzing movement of the optical mouse. For example, one manufacturer may produce the housing while a different manufacturer may produce the remote sensing unit portion. If the housing attaches directly to a computer via the optic fiber cable, a computer manufacturer may produce the computer with an internal interface. Thus, the cost of manufacturing the optical mouse may be lowered considerably.

It is understood that aspects of the present invention can take many forms and embodiments. The embodiments shown herein are intended to illustrate rather than to limit the invention, it being appreciated that variations may be made without departing from the spirit of the scope of the invention. Although illustrative embodiments of the invention have been shown and described, a wide range of modification, change and substitution is intended in the foregoing disclosure and in some instances some features of the present invention may be employed without a corresponding use of the other features. Accordingly, it is appropriate that the appended claims be construed broadly and in a manner consistent with the scope of the invention.

We claim:

1. A computer input device comprising:
a housing including a bottom surface and an upper surface, the bottom surface having an aperture enabling the passage of light therethrough;
an optical fiber segment located at least partially within the housing, the optical fiber segment having a first end positioned to enable light to be transmitted therefrom and through said aperture.

2. The device of claim 1 further comprising a remote sensing unit separate from the housing and connected to the housing via a fiber optic cable, the remote sensing unit including a sensor for detecting movement of the housing.

3. The device of claim 2 wherein fiber optic cable includes a longitudinal section that is transparent.

4. The device of claim 2 wherein the remote sensing unit further includes a light source and a processor and wherein the remote sensing unit includes a connector for connecting to a computer.

5. The device of claim 4 wherein said remote sensing unit includes one of a USB plug, an electrical cable extending therefrom, and a wireless transmitter.

6. The device of claim 4 wherein the remote sensing unit is internal to the computer, the fiber optic cable connecting to the remote sensing unit via a port in the computer.

7. The device of claim 1 wherein the housing contains an endlessly rotatable scroll wheel in which transmission of light over the optical fiber within the housing is based on the rotation of the scroll wheel.

8. The device of claim 1 wherein the housing further comprises at least one switch, the switch having at least a first position and a second position wherein depression of the switch into the second position causes contacting of the switch with the optical fiber within the housing and wherein the contacting causes termination of transmission of light over the optical fiber.

9. The device of claim 8 wherein the housing comprises at least a first switch and a second switch and the optic fiber comprises a first portion and a second portion arranged linearly with the first portion, the first switch and the second switch located between the first portion of and the second portion, said first switch and said second switch having different densities.

10. The device of claim 1 further comprising a remote sensing unit separate from the housing and connected to the housing via a fiber optic cable, the remote sensing unit comprising a pixel array for detecting movement of the housing, the fiber optic cable including an image pipe, the image pipe including a bundle of a plurality of optic fibers, wherein the pixel array detects reflected light transmitted from the housing and having a number of pixels equal to the number of optic fibers in the plurality of optic fibers.

11. The device of claim 1 further comprising a remote sensing unit separate from the housing and connected to the housing via a fiber optic cable, the remote sensing unit including a sensor for detecting movement of the housing, wherein the sensor further includes a first plurality of light sensing elements for sensing reflected light transmitted from the housing and a second plurality of light sensing elements for sensing reflected light transmitted from the housing and wherein light sensing elements of the first plurality of light sensing elements are arranged in a first linear axis for detecting movement of the housing in a first direction parallel to said first linear axis, wherein the light sensing elements of the second plurality of light sensing elements are arranged in a second linear axis for detecting movement of the housing in a second direction parallel to said second linear axis, the second linear axis being approximately perpendicular to said first linear axis.

12. The device of claim 1 further comprising a remote sensing unit separate from the housing and connected to the housing via a fiber optic cable, the remote sensing unit including a cavity and a light source, the cavity receiving reflected light and mixing the reflected light with light from the light source, wherein the reflected light is received at the cavity via at least two optic fibers and wherein mixing of the reflected light via the at least two optic fibers with light from the light source causes distortion of the light from the light source.

13. The device of claim 12 wherein movement of the housing in a first direction is detected based on distortion of the light from a first fiber of the at least two fibers and movement of the housing in a second direction is detected based on distortion of the light from a second fiber of the at least two fibers, the first direction being approximately perpendicular to the second direction.

14. The device of claim 1 wherein the housing further comprises at least a first switch operatively connected to a first group of optic fibers and a second switch operatively connected to a second group of optic fibers, said first group of optic fibers and said second group of optic fibers being operatively connected to said light source, wherein the first group of optic fibers contains a first number of optic fibers and the second group of optic fibers contains a second number of optic fibers, the first number of optic fibers being half of the second number of optic fibers.

15. An apparatus configured to be used to control a cursor on a computer display in accordance with movement of the apparatus with respect to a tracking surface, the apparatus comprising:
a housing having a bottom surface and an upper surface, the bottom surface having an aperture; and
an optical transmission elements enabling light transmitted from outside of the housing to be directed through the aperture and reflected light off of the tracking surface to be transmitted to outside of the housing.

16. The apparatus of claim 15 wherein the housing is void of an optical sensor.

17. The apparatus of claim 15 wherein the housing further includes a primary button, a secondary button and a rotatable wheel, the housing being void of sensors for detecting changes of states of the primary button, secondary button and the rotatable wheel.

18. An electronic mouse system comprising:
a first housing a housing having a bottom surface and an upper surface, the first housing being movable over a surface;
a second housing having a light source; and
an elongated optical element optically coupling the first housing to the second housing.

19. The system of claim 18 wherein the second housing further includes an optical sensor and the first housing further includes a user-engagable displaceable button on the first housing wherein activation of the user-engagable displaceable button and displacement of the first housing is sensed by the optical sensor in the second housing.

20. The system of claim 18 wherein the first housing includes a rotatable wheel therein and rotation of the rotatable wheel is sensed by the optical sensor in the second housing.
